(19) United States
(12) Patent Application Publication
(10) Pub. No.: US 2026/0083618 A1
(43) Pub. Date: Mar. 26, 2026

(54) NEGATIVE-PRESSURE INSTRUMENT

(71) Applicants: Po-Chang LIU, TAOYUAN CITY (TW); BIBOTING INTERNATIONAL CO., LTD., TAOYUAN CITY (TW)

(72) Inventor: Po-Chang LIU, TAOYUAN CITY (TW)

(21) Appl. No.: 18/892,282

(22) Filed: Sep. 20, 2024

(51) Int. Cl. A61H 9/00

(52) U.S. Cl. CPC A61H 9/0057; A61H 2201/013; A61H 2201/1238; A61H 2201/5071

(57) ABSTRACT

A negative-pressure instrument includes an instrument body and a negative-pressure accessory. The negative-pressure accessory is connected to the instrument body through a suction pipe. The instrument body at least includes a connection interface, a circuit board, a vacuum pump, a pressure-sensing module, and a pressure pipe. The vacuum pump is connected to the connection interface and electrically connected to the circuit board. The pressure-sensing module is electrically fixed on the circuit board. One end of the pressure pipe is connected to the connection interface. The other end of the pressure pipe sheathes the pressure-sensing module. Moreover, the circuit board controls the vacuum pump to suck an air from inside of the negative-pressure accessory. The air being sucked is directed to the pressure-sensing module for sensing through the connection interface and the pressure pipe, and then the circuit board determines a negative-pressure inside the negative-pressure accessory.

### BACKGROUND OF THE DISCLOSURE

### Technical Field

The present disclosure relates to a negative-pressure instrument, particularly relates to a negative-pressure instrument which generates negative-pressure and makes a negative-pressure accessory attach onto a skin of a human body.

### Description of Related Art

As the pace of life becomes faster and faster, modern people often do not have enough time to exercise to relax their body and mind, or a lot of pressure may be accumulated and need to be relieved. Therefore, many kinds of massage and stress relief equipment have appeared on the market. A general negative-pressure instrument mainly includes an instrument body and at least one negative-pressure accessory (cup), the instrument body is connected to a negative-pressure accessory by a suction pipe. The user places the negative-pressure accessory on a part of the body that needs a massage. Under the control of the circuit board inside the instrument body, the negative-pressure is established inside the negative-pressure accessory. As a result, massage and relaxation effects on the human body are achieved.

Additionally, when the instrument body is activated and the user just places the negative-pressure accessory (cup), the negative-pressure accessory (cup) may fall off easily due to the vibration motor on the negative-pressure accessory (cup) starting to vibrate before the negative-pressure accessory (cup) is fully attached onto a part of the skin.

Further, some users are used to turning on the instrument body first, then slowly finding the suitable part of the skin to place the negative-pressure accessory (cup). If the negative-pressure accessory (cup) vibrates first, that may cause a bad experience or make the negative-pressure accessory (cup) be unable to fully attach onto the part of the skin.

Therefore, when the vibrator is activated, how to make the negative-pressure accessory be closely and effectively contact the skin of the human body, and prevent the negative-pressure accessory from falling or slipping is a problem needs to be solved by the present disclosure.

### SUMMARY OF THE DISCLOSURE

Therefore, the main purpose of the present disclosure is to solve the problem of the related-art. The present disclosure provides a negative-pressure instrument, in which a pressure-sensing module is disposed inside the instrument body of the negative-pressure instrument. During pumping air, the vibrator on the negative-pressure accessory is activated to generate vibration only when the negative-pressure inside the negative-pressure accessory is sensed to be the predetermined pressure. As a result, the negative-pressure accessory may be prevented from slipping or falling during the vibration.

In order to achieve that purpose, the present disclosure provides a negative-pressure instrument, including: an instrument body; and a negative-pressure accessory, connected to the instrument body through a suction pipe. The instrument body includes a connection interface, a circuit board, a vacuum pump, a pressure-sensing module, and a pressure pipe. The vacuum pump is connected to the connection interface and electrically connected to the circuit board. The pressure-sensing module is electrically fixed on the circuit board. One end of the pressure pipe is connected to the connection interface, and another end of the pressure pipe is connected to the pressure-sensing module. The circuit board is configured to control the vacuum pump to suck an air from inside of the negative-pressure accessory, the air being sucked is directed to the pressure-sensing module for sensing through the connection interface and the pressure pipe, and the circuit board is configured to determine a negative-pressure value in the negative-pressure accessory.

In some embodiments, the instrument body further includes: a base; a case, disposed to cover the base correspondingly; and a panel, fixed to a front side of the case.

In some embodiments, the panel includes: a plurality of operation buttons, a knob, a buzzer, a display, and a switch.

In some embodiments, the circuit board is disposed on an inner side of the panel and electrically connected to the operation buttons, the knob, the buzzer, the display, and the switch.

In some embodiments, the connection interface is fixed on the panel, one end of the connection interface is exposed from the panel, and another end of the connection interface is arranged in the instrument body; the connection interface includes a plurality of adapter pipes disposed on a terminal end thereof, the adapter pipes are respectively connected to the pressure pipe, a solenoid valve tube, and a pump suction tube.

In some embodiments, the vacuum pump is disposed on the base and connected to the connection interface through the pump suction tube.

In some embodiments, the instrument body further includes: a solenoid valve, disposed on the base and electrically connected to the circuit board, and connected to the connection interface through the solenoid valve tube.

In some embodiments, the vacuum pump is connected to a pump releasing tube.

In some embodiments, the negative-pressure accessory includes: a cup body, including a connector connected to one end of the suction pipe.

In some embodiments, the negative-pressure accessory further includes: a vibrator, disposed on an outer surface of the cup body, and electrically connected to the circuit board through a power cable.

### BRIEF DESCRIPTION OF THE DRAWINGS

FIG. 1 is a three-dimensional schematic diagram of the appearance of the instrument body and the negative-pressure accessory of the negative-pressure instrument in accordance with the present disclosure.

FIG. 2 is a schematic diagram of the interior of the instrument body in accordance with the present disclosure.

FIG. 3 is an exploded diagram of the connection interface, the pressure pipe, and the pressure-sensing module in accordance with the present disclosure.

FIG. 4 is a schematic diagram of using status of the negative-pressure instrument in accordance with the present disclosure.

FIG. 5 is a schematic diagram of the negative-pressure instrument in accordance with another embodiment of the present disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

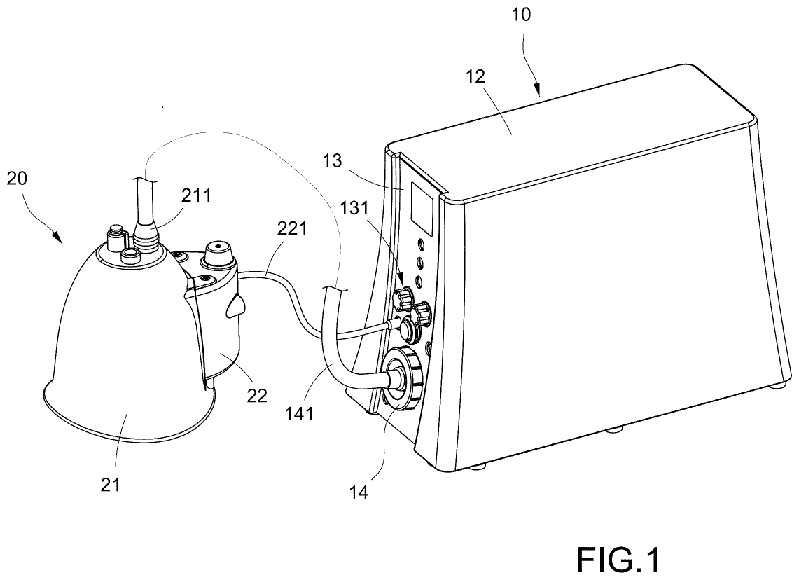

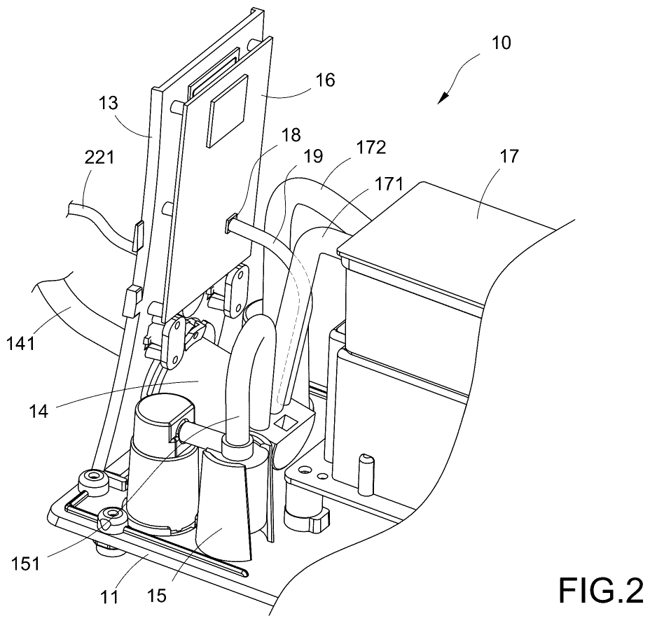

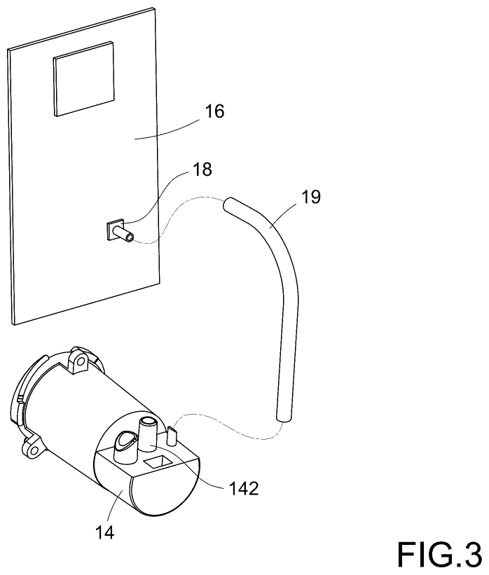

Please refer to FIG. 1˜3, FIG. 1 is a three-dimensional schematic diagram of the appearance of the instrument body and the negative-pressure accessory of the negative-pressure instrument in accordance with the present disclosure, and FIG. 2 is a schematic diagram of the interior of the instrument body in accordance with the present disclosure, and FIG. 3 is an exploded diagram of the connection interface, the pressure pipe and the pressure-sensing module in accordance with the present disclosure. As shown in the figures, the present disclosure provides a negative-pressure instrument. The negative-pressure instrument includes an instrument body 10 and a negative-pressure accessory 20 which are combined to be the negative-pressure instrument.

The instrument body 10 is briefly described. The instrument body 10 includes a base 11, a case 12, and a panel 13. The case 12 is disposed to cover the base 11 correspondingly, and the panel 13 is fixed on the front side of the case 12. The panel 13 includes a plurality of operation buttons 131 and the other related components, for example, a knob, a buzzer, a display, and a switch, etc. The instrument body 10 includes a connection interface 14, a solenoid valve 15, a circuit board 16, a vacuum pump 17, a pressure-sensing module 18, and a pressure pipe 19 disposed inside. The pressure-sensing module 18 is used to monitor the pressure value of the negative-pressure inside the negative-pressure accessory 20.

The connection interface 14 is fixed on the panel 13. One end of the connection interface 14 is exposed from the panel 13, and the other end of the connection interface 14 is arranged inside of the instrument body 10. The connection interface 14 has a suction pipe 141 connected to a structure thereof located outside the panel 13. The other end of the suction pipe 141 is connected to the negative-pressure accessory 20. The terminal end of the connection interface 14 includes a plurality of adapter pipes 142, and the adapter pipes 142 are respectively connected to the pressure pipe 19, a solenoid valve tube 151, and a pump suction tube 171.

The solenoid valve 15 is disposed on the base 11 and connected to the connection interface 14 through the solenoid valve tube 151. The solenoid valve 15 is controlled by the circuit board 16 to release the negative-pressure.

The circuit board 16 is disposed on an inner side of the panel 13 and is electrically connected to the operation buttons 131 and the other related components, for example, the knob, the buzzer, the display, the switch, etc., on the panel 13. Moreover, the circuit board 16 is electrically connected to the solenoid valve 15 and the vacuum pump 17. Therefore, by the operation of the operation buttons 131, the circuit board 16 may control the operation of the solenoid valve 15 and the vacuum pump 17.

The vacuum pump 17 is disposed on the base 11 and is connected, to the connection interface 14 through the pump suction tube 171. The circuit board 16 controls the vacuum pump 17 to make the negative-pressure accessory 20 generate a suction force of negative-pressure. As a result, the negative-pressure accessory 20 may be attached onto a skin of a human body. Besides, the pump releasing tube 172 is connected to the vacuum pump 17 to release gas extracted by the vacuum pump 17 producing the negative-pressure.

The pressure-sensing module 18 is electrically connected to the circuit board 16 to sense the vacuum state of the vacuum pump 17.

One end of the pressure pipe 19 sheathes the pressure-sensing module 18, and the other end of the pressure pipe 19 is connected to the connection interface 14. During the vacuuming operation of the vacuum pump 17, the negative-pressure gas flowing through the connection interface 14 is directed from the pressure pipe 19 to the pressure-sensing module 18 for sensing. The pressure-sensing module 18 may immediately transmit the sensed signal to the circuit board 16 for processing.

The negative-pressure accessory 20 includes a cup body 21 and a vibrator 22. The cup body 21 includes a connector 211 disposed thereon, and the connector 211 is connected to the other end of the suction pipe 141. The vibrator 22 is disposed on an outer surface of the cup body 21 and is electrically connected to the circuit board 16 by a power cable 221. After the cup body 21 performs negative-pressured vacuum suction, the circuit board 16 drives the vibrator 22 to generate vibration for massaging and relieving the human body.

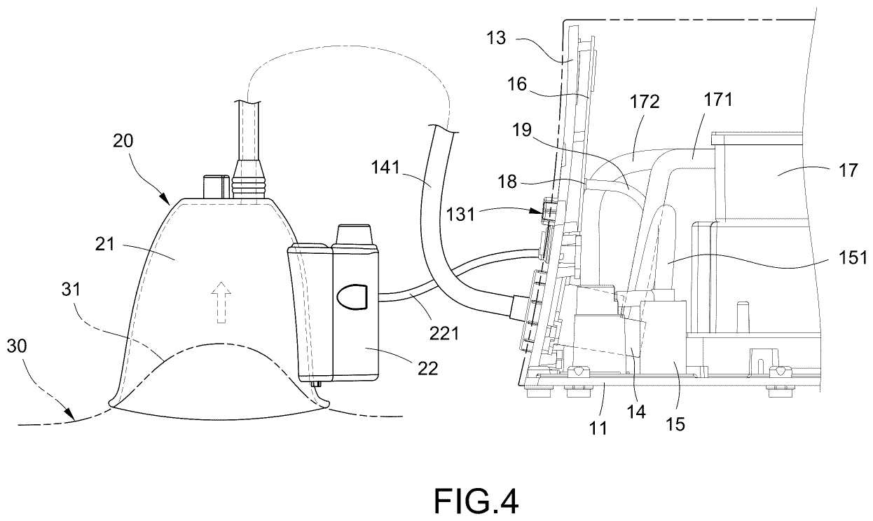

Please refer to FIG. 4, FIG. 4 is a schematic diagram of using status of the negative-pressure instrument in accordance with the present disclosure. As shown in the figure, when the negative-pressure instrument in the present disclosure is in use, the cup body 21 of the negative-pressure accessory 20 is placed on the skin 31 of the human body 30 in advance. At the same time, the operation buttons 131 are used to input signals to the circuit board 16 to make the circuit board 16 drive the vacuum pump 17.

When the vacuum pump 17 is in operation, the air (gas) between the cup body 21 and the skin 31 may be extracted. The extracted air flows through the suction pipe 141, the connection interface 14, and the pump suction tube 171 to the vacuum pump 17, and then is released through the pump releasing tube 172. As a result, the negative-pressure is established between the cup body 21 and the skin 31 and makes the cup body 21 attach onto the skin 31 of the human body 30.

During the air-extraction process of the cup body 21, the pressure pipe 19 may direct the gas being extracted to the pressure-sensing module 18 for sensing. The pressure-sensing module 18 transmits the sensed signal to the circuit board 16. The processor (not shown in figures) on the circuit board 16 determines whether the negative-pressure value in the cup body 21 reaches the predetermined pressure value. If the negative-pressure value reaches the predetermined pressure value, the circuit board 16 controls the vacuum pump 17 to stop operating. Simultaneously, the circuit board 16 immediately drives the vibrator 22 on the cup body 21 to vibrate for massaging and relieving the human body 30.

If the processor of the circuit board 16 determines that the signal sensed by the pressure-sensing module 18 does not reach the predetermined pressure value, the vacuum pump 17 may continuously operate. In the air suction process, when the negative-pressure value inside the cup body 21 does not reach the predetermined pressure value within a predetermined time, the circuit board 16 may drive the buzzer generating a warning, and the display may display that the cup body 21 is not placed properly and the cup body 21 is not in full gas-tight contact with the skin 31. As a result, the user may replace the cup body 21 to be firmly in contact with the skin 31 surfaces of the human body 30.

After the treatment, the signal is inputted to the circuit board 16 through the operation buttons 131, the circuit board 16 may drive the solenoid valve 15 to release the gas. After the negative-pressure inside the cup body 21 is released, the attachment between the cup body 21 and the skin 31 of the human body 30 by the negative-pressure is released, and the cup body 21 may be removed.

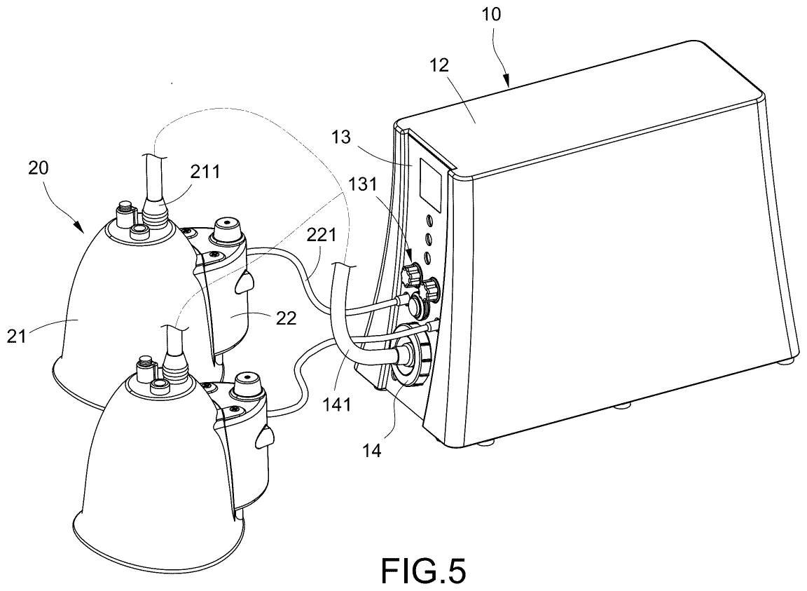

Please refer to FIG. 5, FIG. 5 is a schematic diagram of the negative-pressure instrument in accordance with another embodiment of the present disclosure. As shown in the figure, this embodiment is similar to the FIGS. 1 to 4. The difference is that a divergent connector (not shown in the figures) may be connected to a plurality of negative-pressure accessories 20 through the suction pipe 141. The controlling manners of one or more of the negative-pressure accessories 20 are the same. When the negative-pressure is established between each cup body 21 and the skin 31, the negative-pressure value inside each cup body 21 is the same. Therefore, when the negative-pressure value inside any one of the cup bodies 21 does not reach the predetermined pressure value within a predetermined time, the circuit board 16 may drive the buzzer generating a warning, and the display may display that the cup body 21 is not placed properly and the cup body 21 is not in full gas-tight contact with the skin 31. As a result, the user may replace the cup body 21 to be firmly in contact with the skin 31 surfaces of the human body 30.

While this disclosure has been described by means of specific embodiments, numerous modifications, and variations may be made thereto by those skilled in the art without departing from the scope and spirit of this disclosure set forth in the claims.

What is claimed is:

1. A negative-pressure instrument, comprising:
an instrument body; and
a negative-pressure accessory, connected to the instrument body through a suction pipe;
the instrument body, comprising:
a connection interface;
a circuit board;
a vacuum pump, connected to the connection interface and electrically connected to the circuit board;
a pressure-sensing module, electrically fixed on the circuit board; and
a pressure pipe, one end thereof connected to the connection interface, and another end thereof connected to the pressure-sensing module;
wherein, the circuit board is configured to control the vacuum pump to suck an air from inside of the negative-pressure accessory, the air being sucked is directed to the pressure-sensing module for sensing through the connection interface and the pressure pipe, and the circuit board is configured to determine a negative-pressure value in the negative-pressure accessory.

2. The negative-pressure instrument of claim 1, wherein, the instrument body further comprises:
a base;
a case, disposed to cover the base correspondingly; and
a panel, fixed to a front side of the case.

3. The negative-pressure instrument of claim 2, wherein, the panel comprises:
a plurality of operation buttons, a knob, a buzzer, a display, and a switch.

4. The negative-pressure instrument of claim 3, wherein, the circuit board is disposed on an inner side of the panel and electrically connected to the operation buttons, the knob, the buzzer, the display, and the switch.

5. The negative-pressure instrument of claim 2, wherein, the connection interface is fixed on the panel, one end of the connection interface is exposed from the panel, and another end of the connection interface is arranged in the instrument body; the connection interface comprises a plurality of adapter pipes disposed on a terminal end thereof, the adapter pipes are respectively connected to the pressure pipe, a solenoid valve tube, and a pump suction tube.

6. The negative-pressure instrument of claim 5, wherein, the vacuum pump is disposed on the base and connected to the connection interface through the pump suction tube.

7. The negative-pressure instrument of claim 6, wherein, the instrument body further comprises:
a solenoid valve, disposed on the base and electrically connected to the circuit board, and connected to the connection interface through the solenoid valve tube.

8. The negative-pressure instrument of claim 1, wherein, the vacuum pump is connected to a pump releasing tube.

9. The negative-pressure instrument of claim 8, wherein, the negative-pressure accessory comprises:
a cup body, comprising a connector connected to one end of the suction pipe.

10. The negative-pressure instrument of claim 9, wherein, the negative-pressure accessory further comprises:
a vibrator, disposed on an outer surface of the cup body, and electrically connected to the circuit board through a power cable.
